(19) United States
(12) Patent Application Publication
(10) Pub. No.: US 2020/0011301 A1
(43) Pub. Date: Jan. 9, 2020

(54) WIND TURBINE WITH A TUBULAR SUPPORT STRUCTURE AND A BEARING ASSEMBLY

(71) Applicant: SIEMENS GAMESA RENEWABLE ENERGY A/S, BRANDE (DK)

(72) Inventor: Martin Moeskjaer, Orlando, FL (US)

(21) Appl. No.: 16/482,326

(22) PCT Filed: Jan. 11, 2018
(86) PCT No.: PCT/EP2018/050631

§ 371 Date: Jul. 31, 2019

(30) Foreign Application Priority Data
Feb. 3, 2017 (DE) 10 2017 102 135.3

(51) Int. Cl. F03D 13/20; F03D 80/70; F03D 7/02

(52) U.S. Cl. CPC F03D 13/20; F05B 2240/90; F03D 7/0204; F03D 80/70

(57) ABSTRACT

A support structure for use in a wind turbine is provided. The support structure includes a base, a first aperture, a second aperture and one or more tertiary apertures, and a plurality of openings at the base of the support structure. Further, the first aperture includes a bearing assembly, which in turn includes an outer ring and an inner ring, wherein the bearing assembly is coupled to the first aperture using fastening means. A bearing frame is coupled to the support structure through the outer ring of the bearing assembly. The outer ring of the bearing assembly includes a plurality of bores through which the bearing frame is coupled to the support structure.

### CROSS-REFERENCE TO RELATED APPLICATIONS

This application claims priority to PCT Application No. PCT/EP2018/050631, having a filing date of Jan. 11, 2018, which is based on German Application No. 10 2017 102 135.3, having a filing date of Feb. 3, 2017, the entire contents both of which are hereby incorporated by reference.

### FIELD OF TECHNOLOGY

This following relates to a wind turbine assembly. More particularly, the following relates to a support structure for supporting the components of the wind turbine.

### BACKGROUND

The wind turbines are gaining wide acceptance due to the recent measures to cut down the carbon emission levels. With the acceptance of wind turbines on such a large scale, there is a need to improve the efficiency of the wind turbines at all levels. The structure of wind turbines need to be very efficient with minimum maintenance costs. It should be ensured that there are no recurring maintenance costs due to structural deficiencies.

Generally, the base support structure is the one which supports critical components of the wind turbine such as a main shaft, a gearbox and a generator. The base support structure is designed for distributing the load to the underlying support structures such as a tower of the wind turbine. The base support structure is traditionally designed to have a flat structure with the components of the wind turbine resting thereon. The flat base support structure is enclosed by a casing. This structure is not efficient in transferring the load effectively to the underlying support structures.

A typical geared nacelle design is based on an open nacelle structure, where the drive train is coupled to the top of the nacelle. The structure is composed of a casting material. Further, provisions are made to accommodate bearing housing and gear box. This structure is effective to some extent but there is scope for improvement regarding structural stability of the open nacelle design. The primary challenge is to achieve a desirable level of stiffness in the structure. In particular, it is desirable to have good torsional and tilt stiffness, which lacks in the current base support structure design.

Until now, this problem is addressed by reinforcing the nacelle by adding additional material. For example, the nacelle may be supported by additional ribs and increased wall thickness. Additionally, the height of the nacelle may be increased for more stiffness. The aforementioned solutions marginally increase the structural integrity of the nacelle. There is a need for a better design of a base support structure which provides the required structural efficiency for the wind turbine.

Therefore, there is a need for a bearing cover which can be affixed without the need for bolting to the bearing housing. Further, there is a need for a bearing cover which can be coupled very close to the bearing so that foreign particles do not enter the bearing. Furthermore, there is a need for making the bearing cover lighter and easier to fabricate.

### SUMMARY

An aspect relates to a support structure with a bearing assembly. The support structure comprises a base, a first aperture, a second aperture and one or more tertiary apertures, a plurality of openings at the base of the support structure. Further, the first aperture comprises a bearing assembly comprising an outer ring and an inner ring, wherein the bearing assembly is coupled to the first aperture using fastening means.

In an aspect of embodiments of the invention, the outer ring of the bearing assembly comprises a plurality of bores. The outer ring may be having an increased thickness to accommodate the plurality of bores. The plurality of bores may be adapted to receive a bolting means.

In another aspect of embodiments of the invention, the bearing assembly is coupled to the first opening via the plurality of bores in the outer ring. The outer ring comprises the plurality of bores along the circumference. In some cases, the plurality of bores may be equidistant from each other. In some other cases, the plurality of bores may be spaced at random distances from each other. However, the plurality of bores are arranged at equidistant from the centre of the bearing assembly.

In yet another aspect of embodiments of the invention, the thickness of the outer ring of the bearing assembly is higher than that of the inner ring. The thickness of the outer ring is increased in order to accommodate the plurality of bores. The plurality of bores obviates the need of a bearing housing to couple the bearing to the support structure.

In still other embodiments of invention, the fastening means comprises at least one of a bolting means and a welding means.

In yet another aspect of embodiments of the invention, the plurality of openings at the base of the support structure are configured to accommodate a means for controlling a yaw angle of the wind turbine. For example, the plurality of openings at the base of the support structure may accommodate a motorized unit for controlling the yaw angle of the blades of the wind turbine.

In an aspect of embodiments of the invention, the support structure is adapted to at least partially enclose a power train, a gearbox and a generator. In an exemplary embodiment, the support structure may completely enclose the power train, the gearbox and the generator.

In a further aspect of embodiments of the invention, the support structure is composed of an alloy based material. In another embodiment, the support structure may be composed of a composite material.

The above mentioned and other features of embodiments of the invention will now be addressed with reference to the accompanying drawings of embodiments of the present invention. The illustrated embodiments are intended to illustrated, but not limit embodiments of the invention.

### BRIEF DESCRIPTION

Some of the embodiments will be described in detail, with references to the following Figures, wherein like designations denote like members, wherein:

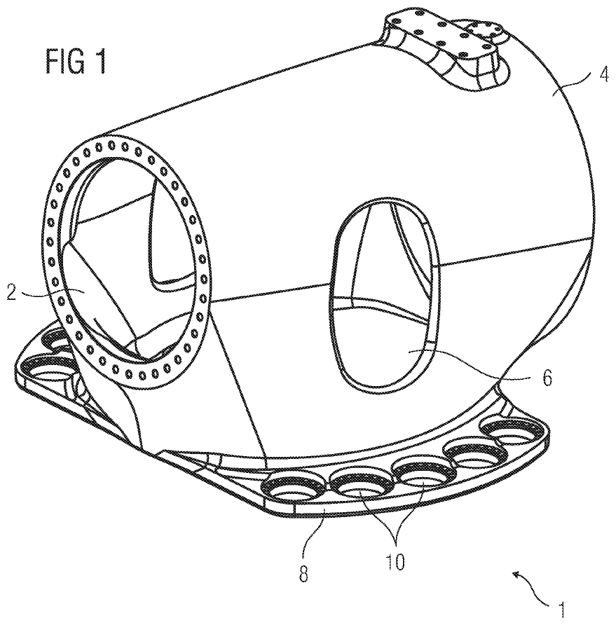

FIG. 1 illustrates a perspective view of a support structure for use in a wind turbine, in accordance with an embodiment;

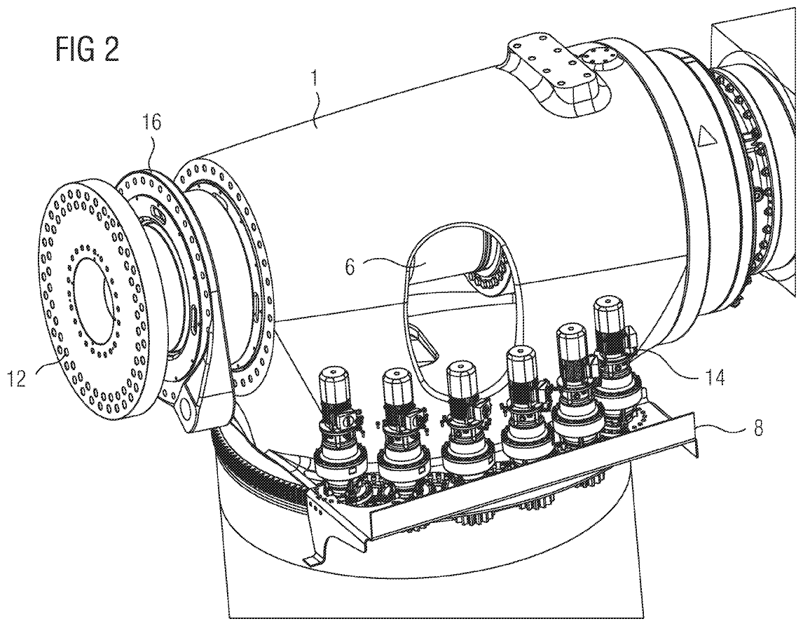

FIG. 2 illustrates a perspective view of the support structure for use in a wind turbine with a main shaft and associated components, in accordance with an embodiment;

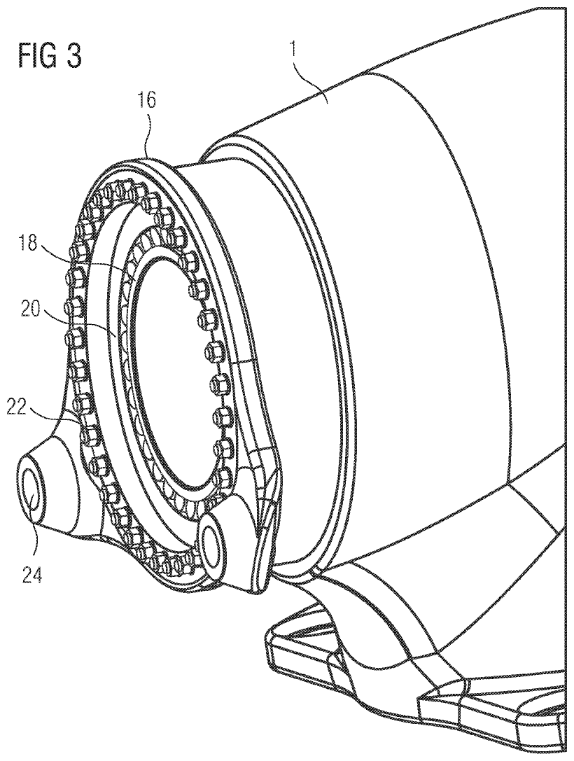

FIG. 3 illustrates a perspective view of the support structure with a bearing frame, in accordance with an embodiment; and

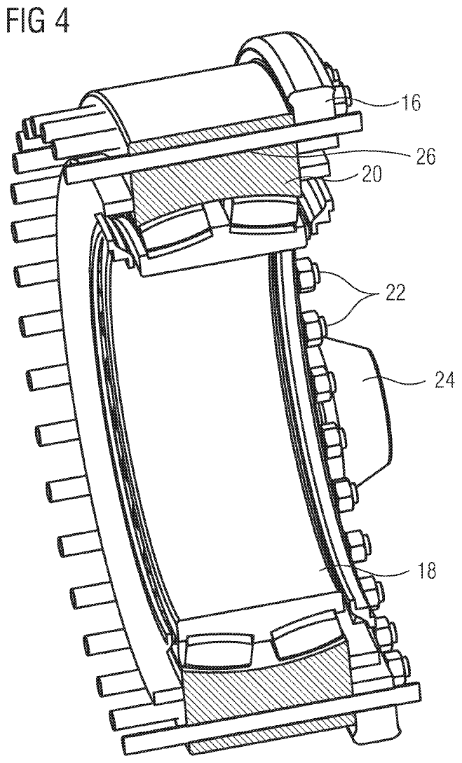

FIG. 4 illustrates a cross sectional view of the support structure with the bearing frame, in accordance with an embodiment.

### DETAILED DESCRIPTION

Various embodiments are described with reference to the drawings, wherein like reference numerals are used to refer like segments throughout. In the following description, for the purpose of explanation, numerous specific details are set forth in order to provide thorough understanding of one or more embodiments. It may be evident that such embodiments may be practiced without these specific details.

FIG. 1 illustrates a perspective view of a support structure 1 for use in a wind turbine, in accordance with an embodiment. The support structure 1 includes a first aperture 2, a second aperture 4, one or more tertiary apertures 6 and a plurality of openings 10 at the base of the support structure 1. The first aperture 2 may be coupled to a main shaft. Further, the first aperture may accommodate a bearing frame. The features of the bearing frame are explained in detail in conjunction with FIG. 3. The second aperture 4 may accommodate a rear portion of the main shaft of the wind turbine. The tertiary aperture 6 may aid in circulation of air within in the support structure 1. Further, the plurality of openings 10 at the base of the support structure 1 may be used for accommodating one or more means for controlling a yaw angle of the wind turbine.

FIG. 2 illustrates a perspective view of the support structure 1 for use in a wind turbine with a main shaft 12 and associated components, in accordance with an embodiment. The main shaft 12 is assembled within the support structure 1. As shown in FIG. 2, the main shaft 12 may be arranged horizontally within the support structure 1. The horizontal central axes of the support structure 1 and the main shaft 12 may coincide. The main shaft 12 may further connect to a drive.

Additionally, a bearing frame 16 is coupled to the first aperture 2 of the support structure 1. The bearing frame 16 is coupled to the support structure 1 via a bearing assembly (shown in FIG. 3). The main shaft 12 passes through the bearing assembly for facilitating rotation. Further details associated with coupling the bearing frame 16 to the first aperture 2 is described in conjunction with FIG. 4. The plurality of openings 10 at the base of the support structure 1 is configured for receiving a means for controlling the yaw angle of the wind turbine.

FIG. 3 illustrates a perspective view of the support structure 1 with a bearing frame 16, in accordance with an embodiment. As shown in FIG. 3, the bearing frame 16 is coupled to the first aperture 2 of the support structure 1. The bearing frame 16 may be coupled to the first aperture 2 via an outer ring 20 of the bearing assembly. The outer ring 20 of the bearing assembly includes a plurality of bores 26 which are configured to receive a fastening means 22. For example, the fastening means 22 may include a bolting means, a magnetic means and a welding means. The bearing frame 16 further includes connecting points 24 which can be used for connecting parts of the wind turbine.

FIG. 4 illustrates a cross sectional view of the support structure 1 with the bearing frame 16, in accordance with an embodiment. In the cross sectional view, it can be seen that the outer ring 20 of the bearing assembly includes a plurality of bores 26. The bearing frame 16 is coupled to the outer ring 20 of the bearing assembly through the plurality of bores 26. In this arrangement, the need for a bearing housing is eliminated. The outer ring 20 of the bearing assembly aids in providing the necessary support for the the bearing frame 16 to clench the first aperture of the support structure 1.

The advantageous embodiments disclosed herein enable an improved design of the support structure 1 to accommodate the components of the wind turbine. The support structure 1 as disclosed herein enables a strong and stable structure with reduced costs. The support structure 1 described herein further has a closed structure unlike the prior art support structures which are open type. The closed structure of the support structure 1 enables significant gain in stiffness for both tilt and torsional loads. Further, the tubular structure provides natural stiffness gain without using walls of high thickness thus reducing the weight and the cost of the support structure 1. The design of the support structure 1 enables uniform support for both the bearing assembly and the main shaft. The support structure 1 is configured to offer a distributed support to the components all around the circumference instead of the traditional point support. Further, there is no need of a bearing housing in the disclosed design of the support structure 1. The outer ring 20 of the bearing assembly is configured to include plurality of bores 26 to couple a bearing frame 16 to the support structure 1. The aforementioned design leads to reduced costs, fewer components and simpler assembly.

Although the invention has been illustrated and described in greater detail with reference to the preferred exemplary embodiment, the invention is not limited to the examples disclosed, and further variations can be inferred by a person skilled in the art, without departing from the scope of protection of the invention.

For the sake of clarity, it is to be understood that the use of “a” or “an” throughout this application does not exclude a plurality, and “comprising” does not exclude other steps or elements.

1. A support structure of a wind turbine, comprising:
a base;
a first aperture, a second aperture and one or more tertiary apertures; and
a plurality of openings at the base of the support structure.

2. The support structure in accordance with claim 1, wherein the first aperture comprises:
a bearing frame for coupling a bearing assembly to the first aperture;
wherein the bearing assembly comprises an outer ring and an inner ring, wherein the bearing assembly is coupled to the first aperture using a fastening means.

3. The support structure in accordance with claim 2, wherein the outer ring of the bearing assembly comprises a plurality of bores.

4. The support structure in accordance with claim 3, wherein the bearing frame is coupled to the support structure via the plurality of bores in the outer ring.

5. The support structure in accordance with claim 2, wherein a thickness of the outer ring of the bearing assembly is higher than that of the inner ring.

6. The support structure in accordance with claim 2, wherein the fastening means comprises at least one of a bolting means and a welding means.

7. The support structure in accordance with claim 1, wherein the plurality of openings at the base of the support structure are configured to accommodate a means for controlling a yaw angle of the wind turbine.

8. The support structure in accordance with claim 7, wherein the means of controlling the yaw angle may be a motorized unit.

9. The support structure in accordance with claim 1, wherein the support structure is adapted to at least partially enclose a main shaft, a gearbox and a generator.

10. The support structure in accordance with claim 1, wherein the support structure is composed of an alloy based material.

11. A wind turbine comprising a support structure in accordance with claim 1.
